(19) United States
(12) Patent Application Publication
(10) Pub. No.: US 2005/0066786 A1
(43) Pub. Date: Mar. 31, 2005

(54) Clamping device for a circular saw

(76) Inventor: Chin-Chin Chang, Taichung Hsien (TW)

Correspondence Address: Connolly Bove Lodge & Hutz LLP, P.O. Box 2207, Wilmington, DE, 19899-2207, US

(21) Appl. No.: 10/672,869

(22) Filed: Sep. 26, 2003

(51) Int. Cl. B26D 7/02

(52) U.S. Cl. 83/452

(57) ABSTRACT

A clamping device for a circular saw includes a body that is adapted to be secured on a worktable of the circular saw. A threaded rod longitudinally extends through the body. A braking block is pivotally mounted to the body for selectively engaged to the threaded rod and torsion spring is mounted between the body and the braking block to provide a restitution force to the braking block. A pin laterally extends through the body and the braking block to hold the braking block in place.

### BACKGROUND OF THE INVENTION

1. Field of the Invention

The present invention relates to a clamping device, and more particularly to a clamping device for a circular saw. The clamping device of the present invention can be quickly moved before clamping the workpiece and provides a certainty clamp force to the workpiece.

2. Description of Related Art

A conventional clamping device for a circular saw in accordance with the prior art comprises a body having a threaded hole defined in and extending through the body. A threaded rod screwed into the threaded hole in the body and extending through the body. The threaded rod includes a first end having a knob secured thereon for user to easily rotate the threaded rod and a second end having a clamping plate pivotally connected to the threaded rod for clamping the workpiece. However, the user needs to spend a lot time to rotate the threaded rod to make the clamping plate abut against the workpiece. It is an inconvenient design.

Consequently, some clamping device manufacturer use an engaging block to selectively engage to the threaded rod such that the threaded rod can be quickly moved when the engaging block is detach from the threaded rod. The engaging block usually has a through hole defined therein and multiple spirals are formed on an inner periphery of the through hole in the engaging block for selectively engaging to the threaded rod. However, the multiple spirals are hard to be manufactured because the spirals are formed on the inner periphery of a through hole. As a result, the longitudinal length of the spirals is shortened for reducing the manufacturing cost. However, the shortened longitudinal length of the spirals cannot provide a good connection between the engaging block and the threaded rod during operating. Consequently, the clamping plate may be moved away from the workpiece due to the vibration of the circular saw when operating.

The present invention has arisen to mitigate and/or obviate the disadvantages of the conventional two clamping devices for a circular saw.

### SUMMARY OF THE INVENTION

The main objective of the present invention is to provide an improved clamping device for a circular saw. The clamping device of the present invention can be quickly moved before clamping the workpiece and provides a certainty clamp force to the workpiece.

To achieve the objective, the clamping device for a circular saw in accordance with the present invention comprises a body that is adapted to be secured on a worktable of the circular saw. A threaded rod longitudinally extends through the body. A braking block is pivotally mounted to the body for selectively engaged to the threaded rod and torsion spring is mounted between the body and the braking block to provide a restitution force to the braking block. A pin laterally extends through the body and the braking block to hold the gracing block in place.

Further benefits and advantages of the present invention will become apparent after a careful reading of the detailed description with appropriate reference to the accompanying drawings.

### BRIEF DESCRIPTION OF THE DRAWINGS

FIG. 1 is a perspective schematic view of a clamping device for a circular saw in accordance with the present invention;

FIG. 2 is an exploded perspective view of the clamping device in FIG. 1;

FIG. 3 is a perspective view of a braking block of the clamping device in accordance with the present invention;

FIG. 4 is a perspective view of the braking black and the body of the clamping device when the braking block is pivotally mounted to the body;

FIG. 5 is an operational side plan view when the clamping device of the present invention prepares to clamp the workpiece on a worktable of the circular saw;

FIG. 6 is an operational side plan view when the threaded rod of the clamping device of the present invention is quickly moved toward the workpiece; and

FIG. 7 is an operational side plan view when the threaded rod is rotated to securely clamp the workpiece after the distal end of the threaded rod abutting against the workpiece.

### DETAILED DESCRIPTION OF THE INVENTION

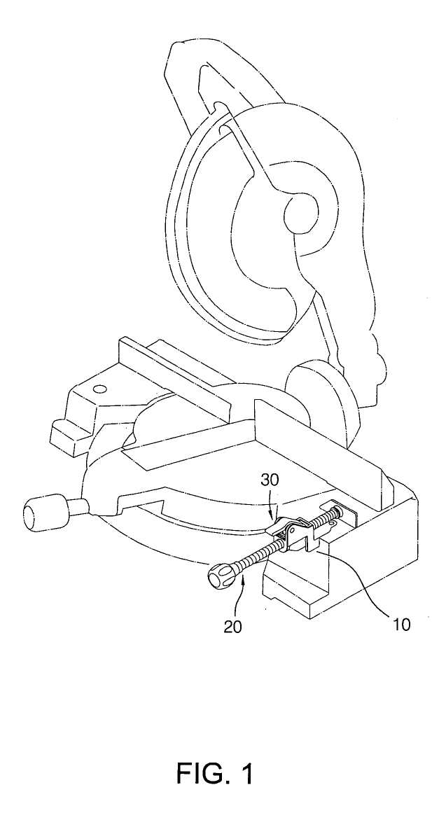

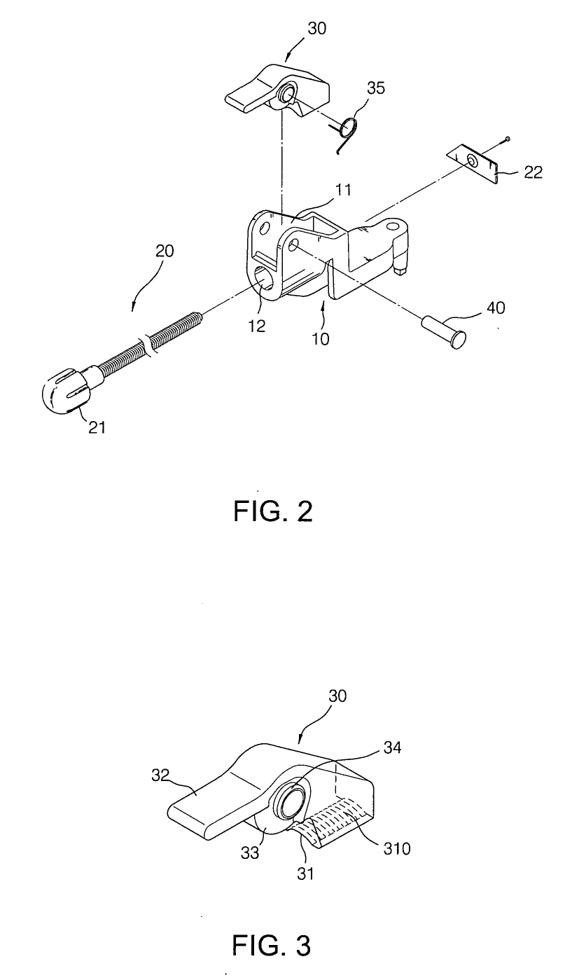

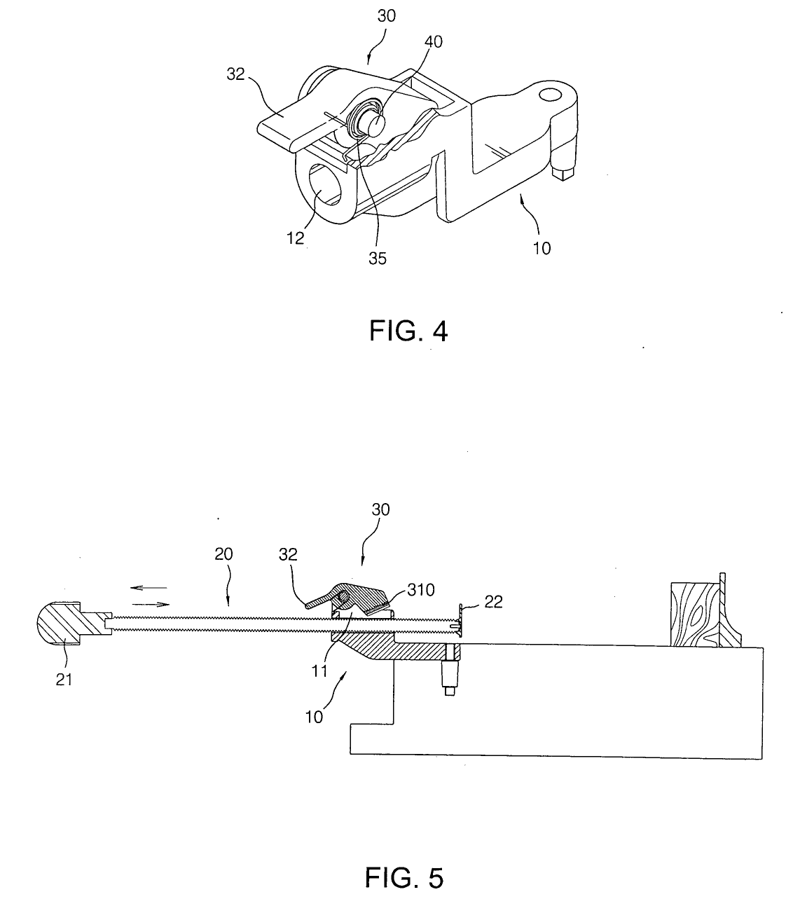

Referring to the drawings and initially to FIGS. 1-4, a clamping device for a circular saw in accordance with the present invention comprises a body (10) adapted to be secured on a worktable of the circular saw, a threaded rod (20) longitudinally extending through the body (10), a braking block (30) pivotally mounted to the body (10) for selectively engaged to the threaded rod (20) and a pin (40) laterally extending through the body (10) and the braking block (30) to hold the braking block (30) in place.

The body (10) includes a through hole (12) longitudinally defined in the body (10) and extending through the body (10). A cavity (11) defined in the body (10) and communicates with the through hole (12).

The threaded rod (20) extends through the body (10) via the through hole (12) in the body (10). The threaded rod (20) includes a first end having a knob (21) secured thereon for user to easily rotate the threaded rod and a second end having a clamping plate (22) pivotally connected to the threaded rod (20) for clamping the workpiece on the worktable of the circular saw.

The braking block (30) is partially received in the cavity (11) in the body (10) and reciprocally pivotally moved relative to the body (10). The braking block (30) includes a curve groove (31) defined in one end of the braking block (30) and having multiple spiral (310) formed on a bottom of the curve groove (31) for selectively engaging to the threaded rod (20). An actuator (32) extends from the braking block (30) for user to press the braking block and make the multiple spirals (310) detach from the threaded rod (20). A recess (33) is defined in one side of the braking block (30) and a protrusion (34) is laterally extending from a bottom of the recess (33). A torsion spring (35) is sleeve on the protrusion (34) and received in the recess (33). The torsion spring (35) has a first end abutting against the body (10) and a second end abutting against the actuator (32) to provide restitution force to the braking block (30) after the user downward press the actuator (32) to make the multiple spirals (310) detach from the threaded rod (20). The pin (40) laterally extends through the body (10) and the braking block (30) relative to the protrusion (34) to hold the braking block (30) in place.

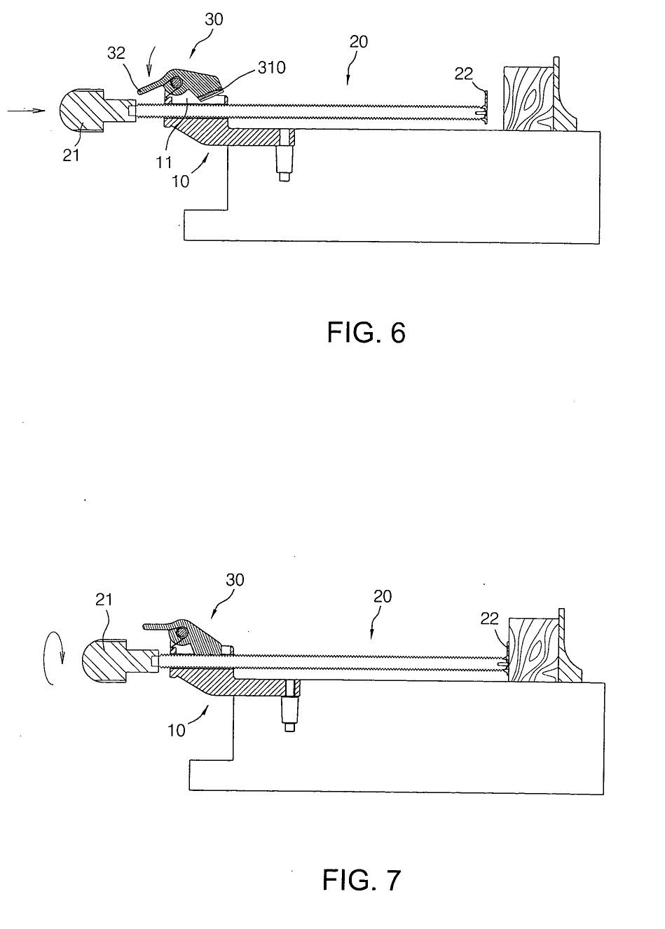

To operate the clamping device of the present invention, with reference to FIGS. 5-7, the threaded rod (20) is in a free condition and can be quickly moved when the actuator (32) is downward pressed. The clamping plate (22) is quickly moved toward the workpiece that is put on the worktable of the circular saw. The braking block (30) is released to make the braking block (30) abutting against the threaded rod (20) and the multiple spirals (310) engaged to the threaded rod (20) due to the restitution force of the torsion spring (35) when the clamping plate (22) abutting against the workpiece. Finally, the threaded rod (20) is rotated to make the clamping plate (22) securely clamp the workpiece due to the engaging relation between the multiple spirals (310) and the threaded rod (20). The actuator (32) is pressed again for quickly releasing the clamping plate (22) from the workpiece.

As described above, the clamping device in accordance with the present invention includes the following advantages.

1. The threaded rod (20) can be quickly moved for shortening the operating time when in a free condition.

2. The engaging length of the threaded rod (20) is elongated such that the present invention can provide a good connection between the braking block (30) and the threaded rod (20).

3. The multiple spirals (310) are easily manufactured because the multiple spirals (310) are formed on the bottom of the curve groove not in a hole of the embodiment of the conventional clamping device for a circular saw.

4. The restitution force of the torsion spring (35) makes the braking block (30) securely abut the threaded rod (20) and provide a good connection between the braking block (30) and the threaded rod (20) to prevent the clamping plate (22) from detaching from the workpiece during operating.

Although the invention has been explained in relation to its preferred embodiment, it is to be understood that many other possible modifications and variations can be made without departing from the spirit and scope of the invention as hereinafter claimed.

1: A clamping device for a circular saw, comprising:
a body adapted to be secured on a worktable of the circular saw, the body including a through hole defined in and extending through the body, a cavity defined in the body and communicating with the through hole;
a threaded rod extending through the body via the through hole in the body, the threaded rod including a first end having a knob secured thereon for user to easily rotate the threaded rod and a second end having a clamping plate pivotally connected to the threaded rod for clamping the workpiece on the worktable of the circular saw;
a braking block partially received in the cavity in the body and reciprocally pivotally moved relative to the body, the braking block including a curve groove defined in one end of the braking block and having multiple spirals formed on a bottom of the curve groove for selectively engaging to the threaded rod, an actuator extending from the braking block for user to press the braking block and make the multiple spirals detach from the threaded rod, a recess is defined in one side of the braking block;
a torsion spring mounted to the braking block and received in the recess in the braking block, the torsion spring has a first end abutting against the body and a second end abutting against the actuator to provide a restitution force to the braking block after the user downward pressing the actuator to make the multiple spirals detach from the threaded rod; and
a pin laterally extending through the body and the braking block to hold the braking block in place.

2. (canceled).

3: The clamping device as claimed in claim 1, wherein a protrusion laterally extends from a bottom of the recess and extends through the torsion spring, the pin extending through the braking block relative to the protrusion.
